(19) United States
(12) Patent Application Publication
(10) Pub. No.: US 2025/0327910 A1
(43) Pub. Date: Oct. 23, 2025

(54) MICROWAVE SENSING DEVICE AND METHOD FOR IMPROVING SENSING ACCURACY

(71) Applicant: Realtek Semiconductor Corp., HsinChu (TW)

(72) Inventors: MINGZHI GUO, Suzhou City (CN); TIANJING ZHANG, Suzhou City (CN)

(73) Assignee: Realtek Semiconductor Corp., HsinChu (TW)

(21) Appl. No.: 19/087,599

(22) Filed: Mar. 24, 2025

(30) Foreign Application Priority Data
Apr. 17, 2024 (CN) 202410465618.9

(51) Int. Cl. G01S 7/487; G01S 7/484; G01S 7/4861

(52) U.S. Cl. CPC G01S 7/4876; G01S 7/484; G01S 7/4861

(57) ABSTRACT

A microwave sensing device includes: a generation circuit, for generating a generation signal; a first processing circuit, for processing the generation signal, to generate a first processed signal; a transmitting circuit, for transmitting the first processed signal; a receiving circuit, for receiving a received signal corresponding to the first processed signal; a second processing circuit, for processing the received signal, to generate a second processed signal; a first transferring circuit, for transferring the second processed signal to a first transferred signal; a removing circuit, for removing a direct current (DC) component of the first transferred signal, to generate a removed signal; a third processing circuit, for processing the removed signal, to generate a third processed signal; and a second transferring circuit, for transferring the third processed signal to a second transferred signal.

### BACKGROUND OF THE INVENTION

### 1. Field of the Invention

The present invention relates to a microwave sensing device and a method used in a wireless communication system, and more particularly, to a microwave sensing device and a method for improving sensing accuracy.

### 2. Description of the Prior Art

A microwave sensing device is an electronic device that uses microwave to sense motion, presence, or distance. During the sensing process, a signal received by the microwave sensing device not only comprises a target signal, but also comprises noise and interference (e.g., a low-frequency flicker noise and a direct current (DC) component of the received signal). This noise and interference reduces the sensing accuracy of the microwave sensing device. Thus, how to improve the sensing accuracy is an important problem to be solved.

### SUMMARY OF THE INVENTION

The present invention provides a microwave sensing device and a method to solve the abovementioned problem.

A microwave sensing device comprises: a generation circuit, for generating a generation signal; a first processing circuit, coupled to the generation circuit, for processing the generation signal, to generate a first processed signal; a transmitting circuit, coupled to the first processing circuit, for transmitting the first processed signal; a receiving circuit, for receiving a received signal corresponding to the first processed signal; a second processing circuit, coupled to the receiving circuit, for processing the received signal, to generate a second processed signal; a first transferring circuit, coupled to the second processing circuit, for transferring the second processed signal to a first transferred signal; a removing circuit, coupled to the first transferring circuit, for removing a direct current (DC) component of the first transferred signal, to generate a removed signal; a third processing circuit, coupled to the removing circuit, for processing the removed signal, to generate a third processed signal; and a second transferring circuit, coupled to the third processing circuit, for transferring the third processed signal to a second transferred signal.

A method for improving a sensing accuracy comprises: generating a generation signal; processing the generation signal, to generate a first processed signal; transmitting the first processed signal; receiving a received signal corresponding to the first processed signal; processing the received signal, to generate a second processed signal; transferring the second processed signal to a first transferred signal; removing a direct current (DC) component of the first transferred signal, to generate a removed signal; processing the removed signal, to generate a third processed signal; and transferring the third processed signal to a second transferred signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a microwave sensing device according to an example of the present invention.

FIG. 2 is a schematic diagram of a microwave sensing device according to an example of the present invention.

FIG. 3 is a schematic diagram of a first processing circuit according to an example of the present invention.

FIG. 4 is a schematic diagram of a second processing circuit according to an example of the present invention.

FIG. 5 is a schematic diagram of a removing circuit according to an example of the present invention.

FIG. 6 is a schematic diagram of a third processing circuit according to an example of the present invention.

FIG. 7 is a schematic diagram of a frequency spectrum of a first processing circuit and a frequency spectrum of a second processing circuit according to an example of the present invention.

FIG. 8 is a schematic diagram of a frequency spectrum of a second filtering circuit and a frequency spectrum of a filtered signal according to an example of the present invention.

FIG. 9 is a flowchart of a process according to an example of the present invention.

### DETAILED DESCRIPTION

According to the Doppler effect, a frequency of a wave source received by an observer is different from a frequency emitted by the wave source, when there is relative motion between the wave source and the observer. The frequency of the wave source received by the observer is called a Doppler frequency. The Doppler frequency fa can be expressed by the following equation:

$${f}_{d} = \frac{2 {vf}_{c}}{c} \qquad ( Eq . 1 )$$

wherein v is a velocity of the wave source, f_{c} is a carrier center frequency, and c is a velocity of light. Table 1 and Table 2 are obtained according to equation (Eq. 1) as follows. Table 1 is a comparison table of the common velocity v of human and the Doppler frequency f_{d} under different carrier center frequencies f_{c}. Table 2 is a comparison table of the velocity v of other high-speed moving objects and the Doppler frequency fa under different carrier center frequencies f_{c}.

TABLE 1

| | | 0.5 & | | |
|---|---|---|---|---|
| v (m/s & km/h) | 0.1 & 0.36 | 1.8 | 1 & 3.6 | 2 & 7.2 |
| f_{d} (Hz) under f_{c} = 2.4 GHZ | 1.6 | 8 | 16 | 32 |
| f_{d} (Hz) under f_{c} = 5.8 GHZ | 3.86667 | 19.3333 | 38.6667 | 77.333 |
| f_{d} (Hz) under f_{c} = 10. 525 GHZ | 7.01667 | 35.0833 | 70.1667 | 140.33 |

TABLE 2

| v (m/s & km/h) | 5 & 18 | 10 & 36 | 20 & 72 | 50 & 180 | 75 & 270 | 100 & 360 | 150 & 540 |
|---|---|---|---|---|---|---|---|
| f_{d} (Hz) | 80 | 160 | 320 | 800 | 1200 | 1600 | 2400 |
| under | | | | | | | |
| f_{c} = 2.4 GHz | | | | | | | |
| f_{d} (Hz) | 193.33 | 386.67 | 773.33 | 1933.33 | 2900 | 3866.7 | 5800 |
| under | | | | | | | |
| f_{c} = 5.8 GHz | | | | | | | |
| f_{d} (Hz) | 350.83 | 701.67 | 1403.3 | 3508.33 | 5262.5 | 7016.7 | 10525 |
| under | | | | | | | |
| f_{c} = 10.525 GHz | | | | | | | |

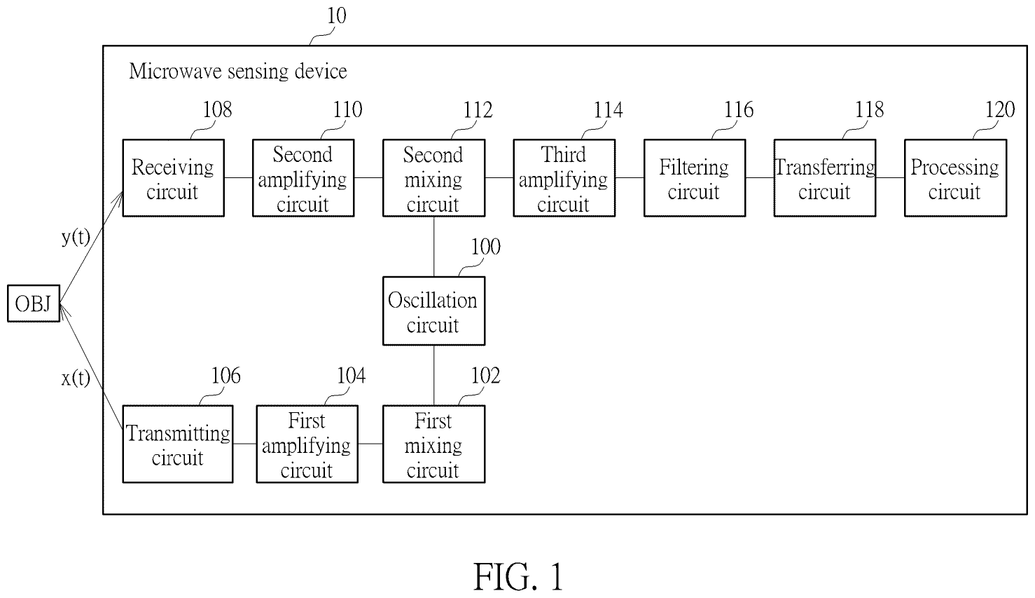

FIG. 1 is a schematic diagram of a microwave sensing device 10 according to an example of the present invention. The microwave sensing device 10 (which can be seen as the observer) is configured to sense a Doppler frequency of a target object OBJ (which can be seen as the wave source) to obtain a velocity of the target object OBJ or a distance between the microwave sensing device 10 and the target object OBJ. In FIG. 1, the microwave sensing device 10 comprises an oscillation circuit 100, a first mixing circuit 102, a first amplifying circuit 104, a transmitting circuit 106, a receiving circuit 108, a second amplifying circuit 110, a second mixing circuit 112, a third amplifying circuit 114, a filtering circuit 116, a transferring circuit 118 and a processing circuit 120. The oscillation circuit 100, the first mixing circuit 102, the first amplifying circuit 104 and the transmitting circuit 106 can be seen as a transmitter. The oscillation circuit 100, the receiving circuit 108, the second amplifying circuit 110, the second mixing circuit 112, the third amplifying circuit 114, the filtering circuit 116, the transferring circuit 118 and the processing circuit 120 can be seen as a receiver.

In the transmitter, the oscillation circuit 100 and the first mixing circuit 102 are configured to generate a signal. The first amplifying circuit 104 may comprises a low-noise amplifier (LNA) and is configured to amplify an amplitude of the signal. That is, the oscillation circuit 100, the first mixing circuit 102 and the first amplifying circuit 104 generate a transmitted signal x(t). Then, the transmitting circuit 106 transmits the transmitted signal x(t). The receiving circuit 108 receives a received signal y(t), after the transmitted signal x(t) is reflected by the target object OBJ. In the receiver, the second amplifying circuit 110 and the third amplifying circuit 114 are configured to amplify signal amplitudes. The second mixing circuit 112 and the oscillation circuit 100 are configured to mix signal frequencies. The filtering circuit 116 is configured to perform a low pass filtering to reserve signals in a frequency band to be observed. The transferring circuit 118 may comprise an analog-to-digital converter (ADC) and is configured to transfer an analog signal to a digital signal. The processing circuit 120 is configured to perform a digital signal processing (DSP). That is, the received signal y(t) is processed by the second amplifying circuit 110, the second mixing circuit 112, the third amplifying circuit 114, the filtering circuit 116, the transferring circuit 118 and the processing circuit 120 to obtain the Doppler frequency of the target object OBJ.

In FIG. 1, an output signal of the oscillation circuit 100 and environmental electromagnetic interference will directly pass to the first mixing circuit 102 and the first amplifying circuit 104, if the oscillation circuit 100, the first mixing circuit 102 and the first amplifying circuit 104 are not isolated well. This phenomenon is called local oscillation leakage. The local oscillation leakage reduces the sensing accuracy of the microwave sensing device 10. Considering an effect of the local oscillation leakage, the received signal y(t) can be expressed as the following equation:

$$y ( t ) = ( ( {I}_{trx , iso} + {\sum }_{k = 0}^{K - 1} {S}_{k} \times δ ( t - {τ}_{k} ) + {\sum }_{l = 0}^{L - 1} {D}_{l} \times δ ( t - {τ}_{l} ) ) \times x ( t ) + {I}_{lo , leakage} \times {e}^{- j 2 π {f}_{c} t} ) \times {e}^{j 2 π {f}_{c} t} \qquad ( Eq . 2 )$$

wherein I_{lo,leakage} is a local oscillation leakage interference (i.e., a power leaking from the transmitter to the receiver), I_{trx,iso} is a near field interference (i.e., a power of the transmitted signal x(t) leaking to the receiver), f_{c} is a carrier center frequency, δ(t) is an impulse function, τₖ/τₗ is a time delay corresponding to the k-th static object/the l-th moving object, and Sₖ/Dₗ is an attenuation coefficient corresponding to the k-th static object/the l-th moving object. A path loss |Dₗ(t)| and a time delay τₗ corresponding to the l-th moving object can be obtained according to the following equation:

$$\vert {D}_{l} ( t ) \vert = \frac{{P}_{t} {G}_{t} {G}_{r} {λ}^{2} {σ}_{l}}{{( 4 π )}^{3} {( {d}_{l} ( t ) )}^{4}} \qquad ( Eq . 3 )$$

$${τ}_{l} ( t ) = \frac{2 {d}_{l} ( t )}{c} \qquad ( Eq . 4 )$$

wherein Pₜ is a transmission power, Gₜ is a gain of the transmitting circuit 106, Gᵣ is a gain of the receiving circuit 108, λ is a wavelength of the transmitted signal x(t), σₗ is a reflectional sectional area of the target object OBJ, and dₗ(t) is a distance between the target object OBJ and the transmitting circuit 106.

Assuming that a velocity and an angle of the l-th moving object are vₗ(t) and θₗ(t) respectively, a Doppler frequency fₗ of the l-th moving object can be derived according to the equation (Eq. 1) as follows:

$${f}_{l} = \frac{2 {v}_{l} ( t ) {θ}_{l} ( t )}{λ} \qquad ( Eq . 5 )$$

An attenuation coefficient of the l-th moving object can be derived according to the equations (Eq. 3) and (Eq. 5) as follows:

$${D}_{l} ( t ) = \frac{{P}_{t} {G}_{t} {G}_{r} {λ}^{2} {σ}_{l}}{{( 4 π )}^{3} {( {d}_{l} ( t ) )}^{4}} \times {e}^{- \frac{j 4 π {v}_{l} ( t ) cos ( {θ}_{l} ( t ) ) t}{λ}} \qquad ( Eq . 6 )$$

Assuming the transmitted signal x(t)=Ae^{-j2πf}^{_{c}}^{t}, wherein A is an amplification coefficient of the first amplifying circuit 104, the received signal y(t) can be rewritten as the following equation:

$$\begin{matrix}y ( t ) = ( {I}_{trx , iso} + {\sum }_{k = 0}^{K - 1} {S}_{k} \times δ ( t - {τ}_{k} ) + {\sum }_{l = 0}^{L - 1} {D}_{l} \times δ ( t - {τ}_{l} ) ) \times A + {I}_{lo , leakage} \\ = {\sum }_{l = 0}^{L - 1} {D}_{l} \times δ ( t - {τ}_{l} ) \times A + ( {I}_{trx , iso} + {\sum }_{k = 0}^{K - 1} {S}_{k} \times δ ( t - {τ}_{k} ) ) \times A + {I}_{lo , leakage} \\ = {\sum }_{l = 0}^{L - 1} \frac{{P}_{t} {G}_{t} {G}_{r} {λ}^{2} {σ}_{l}}{{( 4 π )}^{3} {( {d}_{l} ( t ) )}^{4}} \times {e}^{- \frac{j 4 π {v}_{l} ( t ) cos ( {θ}_{l} ( t ) ) ( t - {τ}_{l} ( t ) )}{λ}} \times A + ( {I}_{trx , iso} + {\sum }_{k = 0}^{K - 1} {S}_{k} \times δ ( t - {τ}_{k} ) ) \times A + {I}_{lo , leakage}\end{matrix} \qquad ( Eq . 7 )$$

wherein

$${\sum }_{l = 0}^{K - 1} \frac{{P}_{t} {G}_{t} {G}_{r} {λ}^{2} {σ}_{l}}{{( 4 π )}^{3} {( {d}_{l} ( t ) )}^{3}} \times {e}^{- \frac{j 4 π {v}_{l} ( t ) cos ( {θ}_{l} ( t ) ) ( t - {τ}_{l} ( t ) )}{λ}} \times A$$

is a dynamic component, and

$$( {I}_{trx , iso} + {\sum }_{k = 0}^{K - 1} {S}_{k} \times δ ( t - {τ}_{k} ) ) \times A + {I}_{lo , leakage}$$

is a direct current (DC) (also called a static component).

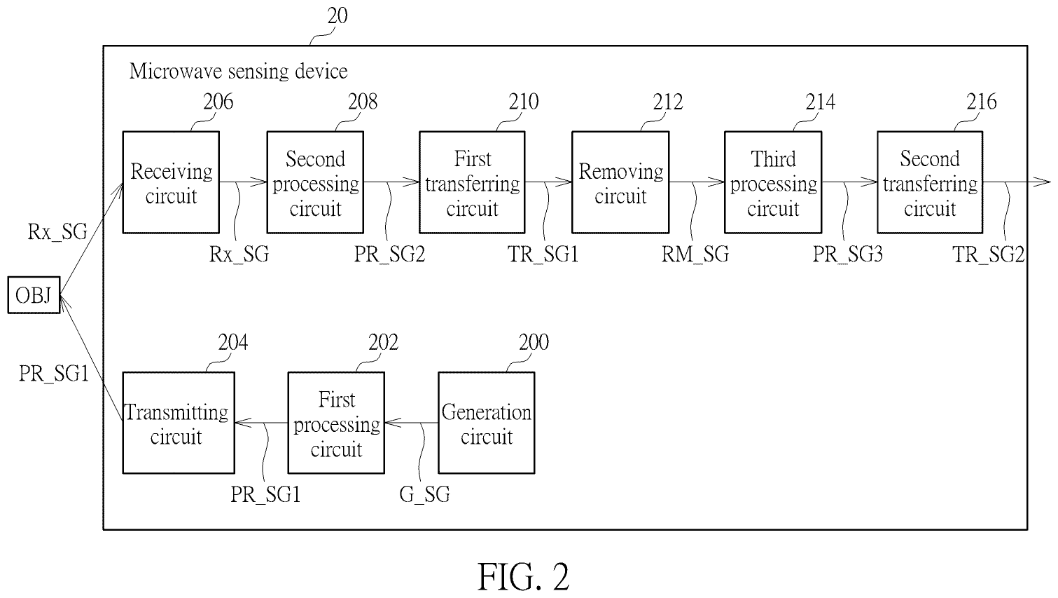

FIG. 2 is a schematic diagram of a microwave sensing device 20 according to an example of the present invention. The microwave sensing device 20 (which can be seen as the observer) is configured to sense a Doppler frequency of a target object OBJ (which can be seen as the wave source) to obtain a velocity of the target object OBJ or a distance between the microwave sensing device 10 and the target object OBJ. In FIG. 2, the microwave sensing device 20 comprises a generation circuit 200, a first processing circuit 202, a transmitting circuit 204, a receiving circuit 206, a second processing circuit 208, a first transferring circuit 210, a removing circuit 212, a third processing circuit 214 and a second transferring circuit 216. The generation circuit 200, the first processing circuit 202 and the transmitting circuit 204 can be seen as a transmitter. The receiving circuit 206, the second processing circuit 208, the first transferring circuit 210, the removing circuit 212, the third processing circuit 214 and the second transferring circuit 216 can be seen as a receiver.

In FIG. 2, the generation circuit 200 is configured to generate a generation signal G_SG. The first processing circuit 202 is coupled to the generation circuit 200, and is configured to process the generation signal G_SG to generate a first processed signal PR_SG1. The transmitting circuit 204 is coupled to the first processing circuit 202, and is configured to transmit the first processed signal PR_SG1. The receiving circuit 206 is configured to receive a received signal Rx_SG corresponding to the first processed signal PR_SG1. In one example, the received signal Rx_SG is a signal received by the receiving circuit 206 after the first processed signal PR_SG1 is reflected by the target object OBJ. The second processing circuit 208 is coupled to the receiving circuit 206, and is configured to process the received signal Rx_SG to generate a second processed signal PR_SG2. The first transferring circuit 210 is coupled to the second processing circuit 208, and is configured to transfer the second processed signal PR_SG2 to a first transferred signal TR_SG1. The removing circuit 212 is coupled to the first transferring circuit 210, and is configured to remove a DC component of the first transferred signal TR_SG1, to generate a removed signal RM_SG. The third processing circuit 214 is coupled to the removing circuit 212, and is configured to process the removed signal RM_SG to generate a third processed signal PR_SG3. The second transferring circuit 216 is coupled to the third processing circuit 214, and is configured to transfer the third processed signal PR_SG3 to a second transferred signal TR_SG2.

In one example, the generation signal G_SG comprises a single carrier signal, and a center frequency of the generation signal G_SG is different (e.g., offset) from a carrier center frequency. In one example, the center frequency of the generation signal G_SG is greater than 10 kHz. In one example, the first transferring circuit 210 comprises a high-speed ADC. In one example, the second transferring circuit 216 comprises a Fourier Transform (FT) circuit. For example, the second transferring circuit 216 performs a Fast Fourier Transform (FFT) or a Discrete Fourier Transform (DFT).

In one example, the microwave sensing device 20 further comprises a detecting circuit (not shown in FIG. 2). The detecting circuit is coupled to the second transferring circuit 216, and is configured to detect a Doppler frequency of a target signal in the second transferred signal TR_SG2. In one example, the microwave sensing device 20 further comprises an oscillation circuit (not shown in FIG. 2). The oscillation circuit is coupled to the first processing circuit 202 and the second processing circuit 208, and is configured to generate a periodical signal and provide the periodical signal to the first processing circuit 202 and the second processing circuit 208. In one example, the oscillation circuit comprises a local oscillator.

In one example, the generation signal G_SG is a digital time-domain signal. In one example, the first processed signal PR_SG1, the received signal Rx_SG and the second processed signal PR_SG2 are analog time-domain signals. In one example, the first transferred signal TR_SG1, the removed signal RM_SG and the third processed signal PR_SG3 are digital time-domain signals. In one example, the second transferred signal TR_SG2 is a digital frequency-domain signal.

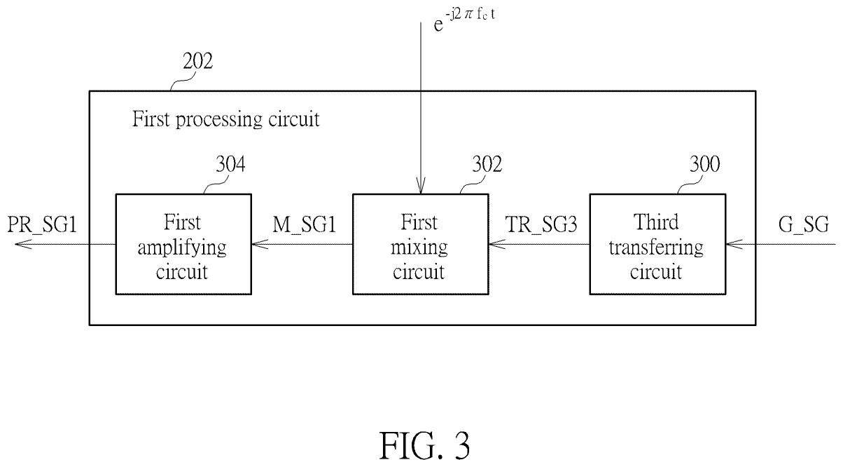

FIG. 3 is a schematic diagram of a first processing circuit 202 according to an example of the present invention. The first processing circuit 202 comprises a third transferring circuit 300, a first mixing circuit 302 and a first amplifying circuit 304. In detail, the third transferring circuit 300 is coupled to the generation circuit 200 in FIG. 2, and is configured to transfer the generation signal G_SG to a third transferred signal TR_SG3. The first mixing circuit 302 is coupled to the third transferring circuit 300, and is configured to mix the third transferred signal TR_SG3 according to the periodic signal (e.g., e^{-j2πf}^{_{c}}^{t}, wherein f_{c} is the carrier center frequency) to generate a first mixed signal M_SG1. The first amplifying circuit 304 is coupled to the first mixing circuit 302, and is configured to amplify an amplitude of the first mixed signal M_SG1 to generate the first processed signal PR_SG1. In one example, the third transferring circuit 300 comprises a digital-to-analog converter (DAC). In one example, the first mixing circuit 302 is coupled to the oscillation circuit, and obtains the periodic signal from the oscillation circuit. In one example, the first amplifying circuit 304 comprises a low-noise amplifier. In one example, the third transferred signal TR_SG3 and the first mixed signal M_SG1 are analog time-domain signals.

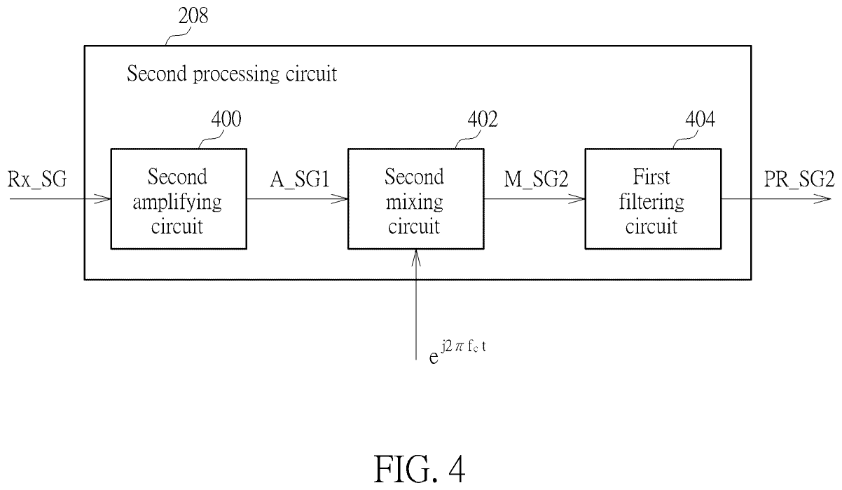

FIG. 4 is a schematic diagram of a second processing circuit 208 according to an example of the present invention. The second processing circuit 208 comprises a second amplifying circuit 400, a second mixing circuit 402 and a first filtering circuit 404. In detail, the second amplifying circuit 400 is coupled to the receiving circuit 206 in FIG. 2, and is configured to amplify an amplitude of the received signal Rx_SG to generate a first amplified signal A_SG1. The second mixing circuit 402 is coupled to the second amplifying circuit 400, and is configured to mix the first amplified signal A_SG1 according to the periodic signal (e.g., e^{j2πf}^{_{c}}^{t}) to generate a second mixed signal M_SG2. The first filtering circuit 404 is coupled to the second mixing circuit 402, and is configured to filter the second mixed signal M_SG2 to generate the second processed signal PR_SG2. In one example, the second amplifying circuit 400 comprises a low-noise amplifier. In one example, the second mixing circuit 402 is coupled to the oscillation circuit, and obtains the periodic signal from the oscillation circuit. In one example, the first filtering circuit 404 comprises a radio frequency (RF) low pass filter (LPF). In one example, the first amplified signal A_SG1 and the second mixed signal M_SG2 are analog time-domain signals.

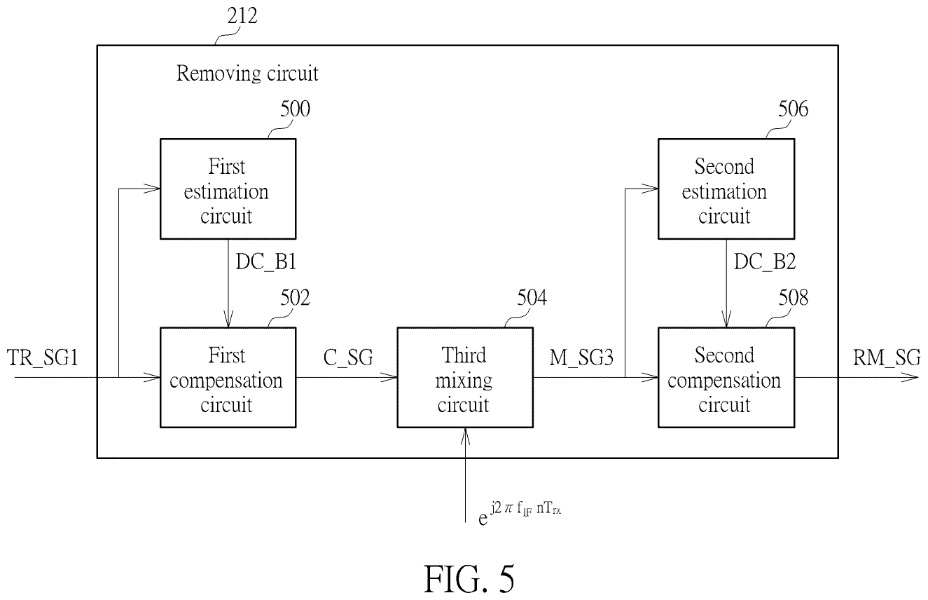

FIG. 5 is a schematic diagram of a removing circuit 212 according to an example of the present invention. The removing circuit 212 comprises a first estimation circuit 500, a first compensation circuit 502, a third mixing circuit 504, a second estimation circuit 506 and a second compensation circuit 508. In detail, the first estimation circuit 500 is coupled to the first transferring circuit 210 in FIG. 2, and is configured to estimate a first DC bias DC_B1 of the first transferred signal TR_SG1. The first compensation circuit 502 is coupled to the first transferring circuit 210 and the first estimation circuit 500, and is configured to compensate the first transferred signal TR_SG1 according to the first DC bias DC_B1 to generate a compensated signal C_SG. The third mixing circuit 504 is coupled to the first compensation circuit 502, and is configured to mix the compensated signal C_SG according to a center frequency f_{IF} of the generation signal G_SG and a sampling period Tᵣₓ (e.g., e^{j2πf}^{_{IF}}^{nT}^{ᵣₓ}) of the first transferring circuit 210 (e.g., the sampling period Tᵣₓ for the first transferred signal TR_SG1) to generate a third mixed signal M_SG3. The second estimation circuit 506 is coupled to the third mixing circuit 504, and is configured to estimate a second DC bias DC_B2 of the third mixed signal M_SG3. The second compensation circuit 508 is coupled to the third mixing circuit 504 and the second estimation circuit 506, and is configured to compensate the third mixed signal M_SG3 according to the second DC bias DC_B2 to generate the removed signal RM_SG. In one example, the compensated signal C_SG and the third mixed signal M_SG3 are digital time-domain signals.

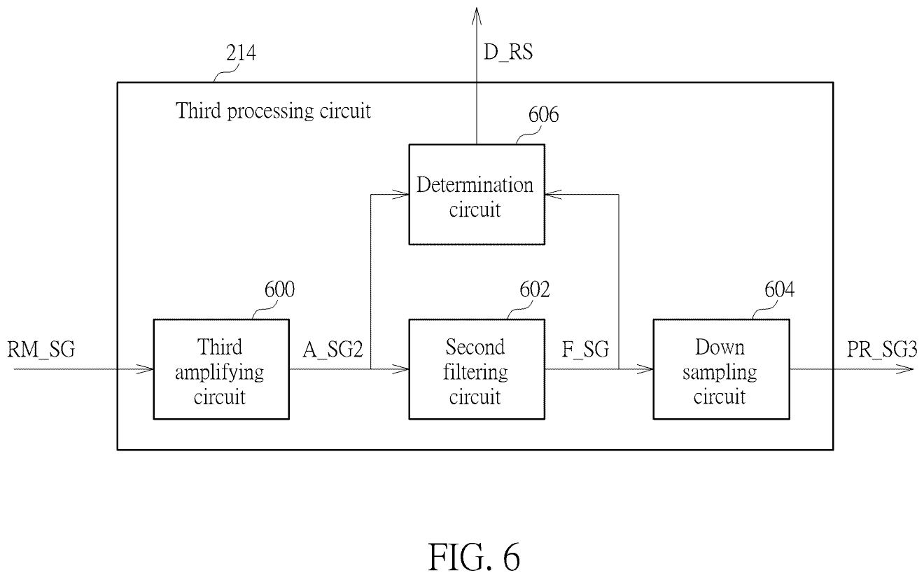

FIG. 6 is a schematic diagram of a third processing circuit 214 according to an example of the present invention. The third processing circuit 214 comprises a third amplifying circuit 600, a second filtering circuit 602, a down sampling circuit 604 and a determination circuit 606. The third amplifying circuit 600 is coupled to the removing circuit 212 in FIG. 2, and is configured to amplify an amplitude of the removed signal RM_SG to generate a second amplified signal A_SG2. The second filtering circuit 602 is coupled to the third amplifying circuit 600, and is configured to filter the second amplified signal A_SG2 to generate a filtered signal F_SG. The down sampling circuit 604 is coupled to the second filtering circuit 602, and is configured to sample the filtered signal F_SG to generate the third processed signal PR_SG3. In one example, the third amplifying circuit 600 comprises a digital amplifier. In one example, the second filtering circuit 602 comprises a digital LPF. In one example, the second amplified signal A_SG2 and the filtered signal F_SG are digital time-domain signals.

In FIG. 6, the determination circuit 606 is coupled to the third amplifying circuit 600 and the second filtering circuit 602, and is configured to determine whether the second amplified signal A_SG2 comprises an interference according to the filtered signal F_SG to generate a determination result D_RS. In one example, the determination circuit 606 is coupled to the removing circuit 212 in FIG. 2. The removing circuit 212 removes the DC component of the first transferred signal TR_SG1 according to the determination result D_RS. In one example, the determination circuit 606 is coupled to the first estimation circuit 500 in FIG. 5. The first estimation circuit 500 estimates the first DC bias DC_B1 of the first transferred signal TR_SG1 according to the determination result D_RS. In one example, the determination circuit 606 is coupled to the second estimation circuit 506 in FIG. 5. The second estimation circuit 506 estimates the second DC bias DC_B2 of the third mixed signal M_SG3 according to the determination result D_RS.

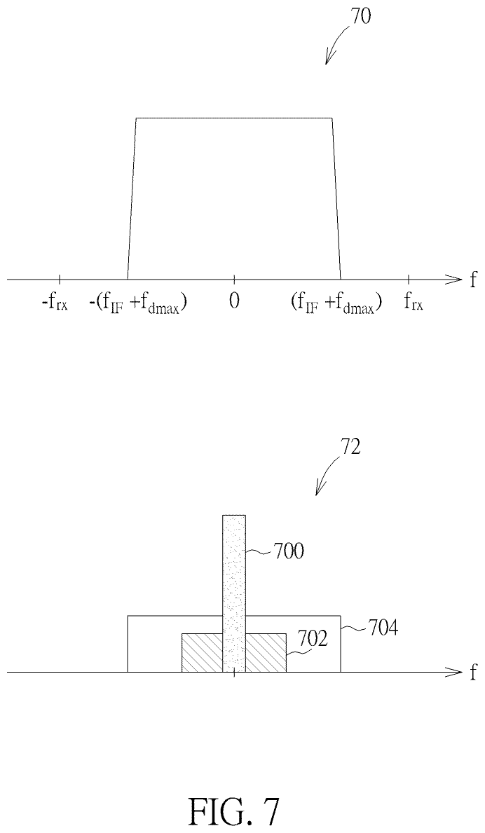

FIG. 7 is a schematic diagram of a frequency spectrum 70 of a first processing circuit 404 and a frequency spectrum 72 of a second processing circuit PR_SG2 according to an example of the present invention. In the frequency spectrum 70 of the first processing circuit 404, fᵣₓ is a passband cutoff frequency of the first processing circuit 404, f_{IF} is a center frequency of the generation signal G_SG, and f_{dmax} is a maximum Doppler frequency to be observed. The frequency spectrum 72 of the second processed signal PR_SG2 is obtained via the first filtering circuit 404. The second processed signal PR_SG2 comprises a target sensing signal 700, an RF noise 702 and a normalized noise 704.

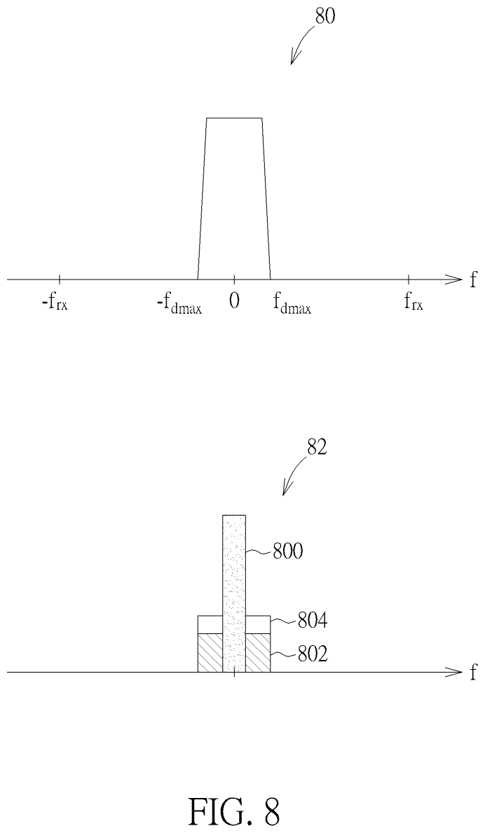

FIG. 8 is a schematic diagram of a frequency spectrum 80 of a second filtering circuit 602 and a frequency spectrum 82 of a filtered signal F_SG according to an example of the present invention. In the frequency spectrum 80 of the second filtering circuit 602, fᵣₓ is a passband cutoff frequency of the first processing circuit 404, and f_{dmax} is a maximum Doppler frequency to be observed. The frequency spectrum 82 of the filtered signal F_SG is obtained via the second filtering circuit 602. The filtered signal F_SG comprises a target sensing signal 800, an RF noise 802 and a normalized noise 804.

The following example is used for illustrating how the microwave sensing device 20 senses the Doppler frequency of the target signal. First, a generation signal x_{BB,TX}(n) (e.g., the generation signal G_SG) generated by the generation circuit 200 can be expressed as the following equation:

$${x}_{BB , TX} ( n ) = {e}^{- j 2 π {f}_{IF} {nT}_{tx}} \qquad ( Eq . 8 )$$

wherein f_{IF} is a center frequency of the generation signal x_{BB,TX}(n), and Tₜₓ is a sampling period of the third transferring circuit 300. It should be noted that the low-frequency flicker noise usually locates at 1.x kHz. The center frequency f_{IF} of the generation signal x_{BB,TX}(n) may be greater than 10 kHz in order to avoid the effect of the low-frequency flicker noise. Then, the third transferring circuit 300, the first mixing circuit 302 and the first amplifying circuit 304 in the first processing circuit 202 process the generation signal x_{BB,TX}(n), to generate a first processed signal x_{RF,TX}(t) (e.g., the first processed signal PR_SG1) as follows:

$${x}_{RF , TX} ( t ) = {Ae}^{- j 2 π ( {f}_{IF} + {f}_{c} ) t} \qquad ( Eq . 9 )$$

wherein f_{c} is a carrier center frequency, and A is an amplification coefficient of the first amplifying circuit 304.

The receiving circuit 206 receives a received signal (e.g., the received signal Rx_SG), after the transmitting circuit 204 transmits the first processed signal x_{RF,TX}(t) and the first processed signal x_{RF,TX}(t) is reflected by the target object OBJ. A second processed signal y_{RF,RX}(t) (e.g., the second processed signal PR_SG2) is obtained through the second amplifying circuit 400, the second mixing circuit 402 and the first filtering circuit 404 in the second processing circuit 208 to process the received signal. The second processed signal y_{RF,RX}(t) can be expressed as the following equation:

$$\begin{matrix}{y}_{RF , RX} ( n ) = {Ae}^{- j 2 π ( {f}_{IF} + {f}_{c} ) t} \times {G}_{LAN} \times {e}^{j 2 π {f}_{c} t} \times ( {I}_{trx , iso} \times δ ( t - {τ}_{trx , iso} ) + {\sum }_{k = 0}^{K - 1} {S}_{k} \times δ ( t - {τ}_{k} ) + {\sum }_{l = 0}^{L - 1} {D}_{l} \times {e}^{- j 2 π {f}_{d , l} \times n \times {T}_{rx}} \times δ ( t - {τ}_{l} ) ) \\ = A \times {G}_{LAN} \times {e}^{- j 2 π {f}_{IF} t} \\ \times ( {I}_{trx , iso} \times δ ( t - {τ}_{trx , iso} ) + {\sum }_{k = 0}^{K - 1} {S}_{k} \times δ ( t - {τ}_{k} ) \\ + {\sum }_{l = 0}^{L - 1} {D}_{l} \times {e}^{- j 2 π {f}_{d , l} t} \times δ ( t - {τ}_{l} ) ) + {w}_{RF} ( t )\end{matrix} \qquad ( Eq . 10 )$$

wherein G_{LAN} is an amplification coefficient (or an amplification gain) of the second amplifying circuit 400, δ(t) is an impulse function, fan is a Doppler frequency corresponding to the l-th moving object, I_{trx,iso}/Sₖ/Dₗ is an attenuation coefficient corresponding to a near field interference noise/the k-th static object/the l-th moving object, τ_{trx,iso}/τₖ/τₗ is a time delay corresponding to the near field interference noise/the k-th static object/the l-th moving object, and w_{RF}(t) is an RF noise. The RF noise w_{RF}(t) comprises amplifier noises of the first amplifying circuit 304 and the second amplifying circuit 400.

Then, the first transferring circuit 210 (e.g., the high-speed ADC) transfers the second processed signal y_{RF,RX}(t) to a first transferred signal y_{ADC,RX}(n) (e.g., the first transferred signal TR_SG1) as follows:

$$\begin{matrix}{y}_{ADC , RX} ( n ) = A \times {G}_{LAN} \times G \times {e}^{- j 2 π {f}_{d , l} \times n \times {T}_{rx}} \\ \times ( {I}_{trx , iso} \times δ ( t - {τ}_{trx , iso} ) + {\sum }_{k = 0}^{K - 1} {S}_{k} \times δ ( t - {τ}_{k} ) \\ + {\sum }_{l = 0}^{L - 1} {D}_{l} \times {e}^{- j 2 π {f}_{d , l} \times n \times {T}_{rx}} \times δ ( t - {τ}_{l} ) ) \\ + {w}_{RF} ( n ) + {w}_{quan} ( n ) + Bias ( n )\end{matrix} \qquad ( Eq . 11 )$$

wherein G is a total amplification gain of the third transferring circuit 300, the first mixing circuit 302, the transmitting circuit 204, the receiving circuit 206, the second mixing circuit 402 and the first filtering circuit 404, Tᵣₓ is a sampling period of the first transferring circuit 210, w_{RF}(n) is an RF noise, w_{quan}(n) is a normalized noise of the first transferring circuit 210, and Bias(n) is a DC component caused by the receiving circuit 206, the second amplifying circuit 400, the second mixing circuit 402, the first filtering circuit 404 and the first transferring circuit 210. That is, G is the amplification gain of an RF chain of the microwave sensing device 20 (but excluding the amplifying circuits), and Bias(n) is the DC component caused by the RF chain of the microwave sensing device 20. w_{RF}(n) is related to noise coefficients of the first amplifying circuit 304 and the second amplifying circuit 400 and a bandwidth of the first filtering circuit 404. w_{quan}(n) is related to the sampling period Tᵣₓ of the first transferring circuit 210.

Then, the removing circuit 212 removes the DC component of the first transferred signal y_{ADC,RX}(n). In detail, the first estimation circuit 500 estimates a first DC bias \hat{B}ias1(n) (e.g., the first DC bias DC_B1) as follows:

$$\hat{B} ias 1 ( n ) = {\sum }_{m = n - N + 1}^{n} {y}_{ADC , RX} ( m ) / N \qquad ( Eq . 12 )$$

wherein N is a number of sampling points of y_{ADC,RX}(m) for estimating the first DC bias \hat{B}ias1(n). Assuming that the Doppler frequency is 10 Hz, an estimation time for the first estimation circuit 500 is not less than 100 milliseconds (ms). Thus, the first compensation circuit 502 can obtain a compensated signal y_{BB1}(n) (e.g., the compensated signal C_SG) as follows:

$$\begin{matrix}{y}_{BB 1} ( n ) = {y}_{ADC , RX} ( n ) - \hat{B} ias 1 ( n ) \\ = K \times {e}^{- j 2 π {f}_{IF} \times n \times {T}_{rx}} \\ \times ( {I}_{trx , iso} \times δ ( t - {τ}_{trx , iso} ) + {\sum }_{k = 0}^{K - 1} {S}_{k} \times δ ( t - {τ}_{k} ) \\ + {\sum }_{l = 0}^{L - 1} {D}_{l} \times {e}^{- j 2 π {f}_{d , l} \times n \times {T}_{rx}} \times δ ( t - {τ}_{l} ) ) \\ + {w}_{RF} ( n ) + {w}_{quan} ( n ) + Bias ( n ) - \hat{B} ias 1 ( n )\end{matrix} \qquad ( Eq . 13 )$$

wherein K=A×G_{LAN}×G. Since Bias(n)≈\hat{B}ias1(n), y_{BB1}(n) can be rewritten as the following equation:

$$\begin{matrix}{y}_{BB 1} ( n ) \approx K \times {e}^{- j 2 π {f}_{IF} \times n \times {T}_{rx}} \\ \times ( {I}_{trx , iso} \times δ ( t - {τ}_{trx , iso} ) + {\sum }_{k = 0}^{K - 1} {S}_{k} \times δ ( t - {τ}_{k} ) \\ + {\sum }_{l = 0}^{L - 1} {D}_{l} \times {e}^{- j 2 π {f}_{d , l} \times n \times {T}_{rx}} \times δ ( t - {τ}_{l} ) ) \\ + {w}_{RF} ( n ) + {w}_{quan} ( n )\end{matrix} \qquad ( Eq . 14 )$$

The third mixing circuit 504 mixes the compensated signal y_{BB1}(n) according to the center frequency of f_{IF} the generation signal x_{BB,TX}(n) and the sampling period Tᵣₓ of the first transferring circuit 210, to generate a third mixed signal y_{BB2}(n) (e.g., the third mixed signal M_SG3) as follows:

$$\begin{matrix}{y}_{BB 4} ( n ) = {y}_{BB 1} ( n ) \times {e}^{j 2 π {f}_{IF} \times n \times {T}_{rx}} \\ = K \times ( {I}_{trx , iso} \times δ ( t - {τ}_{trx , iso} ) + {\sum }_{k = 0}^{K - 1} \times δ ( t - {τ}_{k} ) \\ + {\sum }_{l = 0}^{L - 1} {D}_{l} \times {e}^{- j 2 π {f}_{d , l} \times n \times {T}_{rx}} \times δ ( t - {τ}_{l} ) \\ + {w}_{RF} ( n ) + {w}_{quan} ( n )\end{matrix} \qquad ( Eq . 15 )$$

The second estimation circuit 506 estimates a second DC bias \hat{B}ias2(n) (e.g., the second DC bias DC_B2) as follows:

$$\hat{B} ias 2 ( n ) = {\sum }_{m = n - N + 1}^{n} {y}_{BB 2} ( m ) / N \qquad ( Eq . 16 )$$

wherein N is a number of y_{BB2}(n) for estimating the DC bias \hat{B}ias2(n). Assuming that the Doppler frequency is 10 Hz, an estimation time for the second estimation circuit 506 is not less than 100 ms. Thus, the second compensation circuit 508 can obtain a removed signal y_{BB3}(n) (e.g., the removed signal RM_SG) as follows:

$$\begin{matrix}{y}_{BB 3} ( n ) = {y}_{BB 2} ( n ) - \hat{B} ias 2 ( n ) \\ \approx K \times {\sum }_{l = 0}^{L - 1} {D}_{l} \times {e}^{- j 2 π {f}_{d , l} \times n \times {T}_{rx}} \times δ ( t - {τ}_{l} ) \\ + {w}_{RF} ( n ) + {w}_{quan} ( n )\end{matrix} \qquad ( Eq . 17 )$$

Most interference is removed through the removing circuit 212 removing the DC component of the first transferred signal y_{ADC,RX}(n).

Then, the third processing circuit 214 processes the removed signal y_{BB3}(n), to increase a signal-to-noise ratio (SNR) of the removed signal y_{BB3}(n). In detail, an amplification coefficient Gₐₘₚ of the third amplifying circuit 600 is shown as follows:

$${G}_{amp} = \frac{{A}_{target}}{( {\sum }_{m = n - N + 1}^{n} {‖ {y}_{ADC , RX} ( n ) ‖}^{2} ) / N} \qquad ( Eq . 18 )$$

wherein A_{target} is a target amplification coefficient. The third amplifying circuit 600 amplifies the removed signal y_{BB3}(n) according to the amplification coefficient Gₐₘₚ as follows:

$$\begin{matrix}{y}_{BB 4} ( n ) = {G}_{amp} \times {y}_{BB 3} ( n ) \\ = {G}_{amp} \times K \times {\sum }_{l = 0}^{L - 1} {D}_{l} \times {e}^{- j 2 π {f}_{d , l} \times n \times {T}_{rx}} \times δ ( t - {τ}_{l} ) \\ + {w}_{RF} ( n ) + {w}_{quan} ( n )\end{matrix} \qquad ( Eq . 19 )$$

wherein y_{BB4}(n) is a signal (e.g., the second amplified signal A_SG2) after the removed signal y_{BB3}(n) is amplified by the third amplifying circuit 600.

The second filtering circuit 602 performs the LPF for the signal y_{BB4}(n), to generate a filtered signal y_{BB,LPF}(n) (e.g., the filtered signal F_SG). A frequency spectrum of the second filtering circuit 602 can be known by referring to the frequency spectrum 80 in FIG. 8. Compared with the first transferred signal y_{ADC,RX}(t) generated after the first transferring circuit 210 transfers the second processed signal y_{RF,RX}(t), a normalized noise of the filtered signal y_{BB,LPF}(n) is reduced by 10 log₁₀(fᵣₓ/f_{dmax}) decibels (dB), wherein f_{dmax} is a maximum Doppler frequency to be observed and fᵣₓ is a passband cutoff frequency of the first filtering circuit 404. Compared with the first transferred signal y_{ADC,RX}(t) generated after the first transferring circuit 210 transfers the second processed signal y_{RF,RX}(t), an RF of the filtered signal y_{BB,LPF}(n) is reduced by 10 log₁₀(f_{LPF}/f_{dmax}) dB, wherein f_{LPF} is a passband cutoff frequency of the second filtering circuit 602. That is, the SNR is increased via the removing circuit 212 and the third processing circuit 214.

The down sampling circuit 604 samples the filtered signal y_{BB,LPF}(n), to generate a third processed signal y_{BB,S}(n) (e.g., the third processed signal PR_SG3). The second transferring circuit 216 performs the FFT or the DFT for the third processed signal y_{BB,S}(n), to obtain a second transferred signal Y_{BB,S}(f) (e.g., the second transferred signal TR_SG2) and its frequency spectrum. The frequency spectrum of the second transferred signal Y_{BB,S}(f) can be known by referring to the frequency spectrum 82 in FIG. 8. The detecting circuit detects a Doppler frequency of the target signal in the second transferred signal Y_{BB,S}(f) according to the frequency spectrum of the second transferred signal Y_{BB,S}(f).

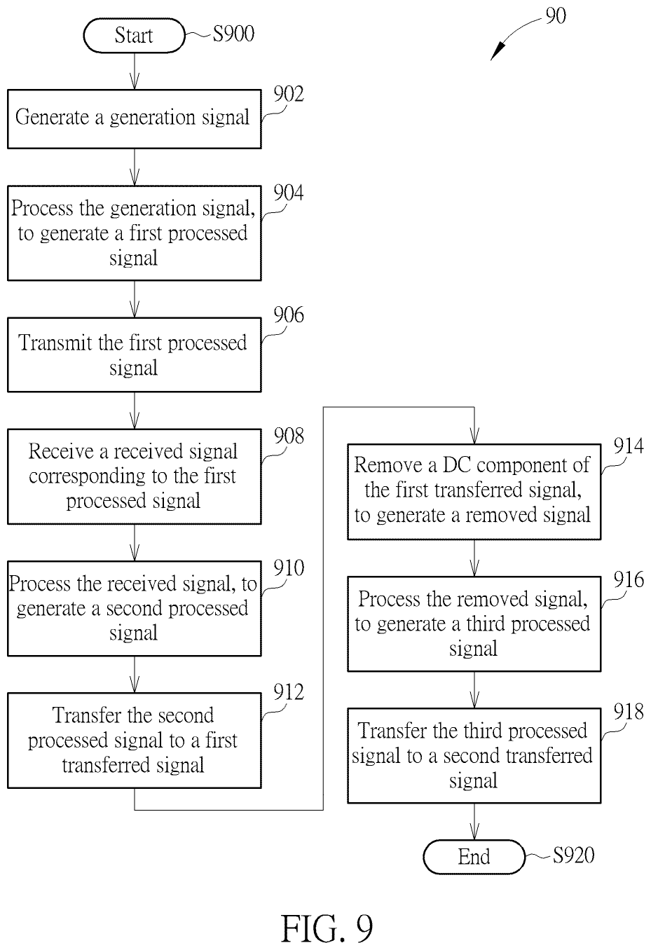

Operations of the microwave sensing device 20 in the above examples can be summarized into a process 90 shown in FIG. 9, which includes the following steps:
Step S900: Start.
Step S902: Generate a generation signal.
Step S904: Process the generation signal, to generate a first processed signal.
Step S906: Transmit the first processed signal.
Step S908: Receive a received signal corresponding to the first processed signal.
Step S910: Process the received signal, to generate a second processed signal.
Step S912: Transfer the second processed signal to a first transferred signal.
Step S914: Remove a DC component of the first transferred signal, to generate a removed signal.
Step S916: Process the removed signal, to generate a third processed signal.
Step S918: Transfer the third processed signal to a second transferred signal.
Step S920: End.

The process 90 is used for illustrating the operations of the microwave sensing device 20. A detailed description and variations of the process 90 can be known by referring to the above description, and are not narrated herein.

It should be noted that there are various possible realizations of the microwave sensing devices 10 and 20 and the circuits included in the microwave sensing devices 10 and 20. For example, the devices (circuits) mentioned above may be integrated into one or more devices (circuits). In addition, the microwave sensing devices 10 and 20 and the circuits in the microwave sensing devices 10 and 20 may be realized by hardware (e.g., circuits), software, firmware (known as a combination of a hardware device, computer instructions and data that reside as read-only software on the hardware device), an electronic system or a combination of the devices mentioned above, but are not limited herein.

The operation of “determine” described above may be replaced by the operation of “compute”, “calculate”, “obtain”, “generate”, “output, “use”, “choose/select”, “decide” or “is configured to”. The operation of “detect” described above may be replaced by the operation of “monitor”, “receive”, “sense” or “obtain”. The phrase “according to” described above may be replaced by “in response to”. The term “corresponding to” described above may be replaced by “of” or “associated with”. The term “via” described above may be replaced by “on”, “in” or “at”. The term “when” or “if” described above may be replaced by “in response to”.

To sum up, the present invention provides a microwave sensing device and a method for improving sensing accuracy. The generation comprises a single carrier signal, wherein the center frequency of the generation signal is different (e.g., offset) from a carrier center frequency, which avoids the effect of the low-frequency flicker noise. The first transferring circuit comprises the high-speed ADC. In the removing circuit, the estimation circuit obtains the DC bias via a long-term estimation training, and the compensation circuit performs the compensation according to the estimated DC bias to remove the DC bias. The third processing circuit comprises the determination circuit which determines whether the received signal is interfered with by other wireless devices. The first transferring circuit, the removing circuit and the third processing circuit improve the SNR. Thus, the problem of improving sensing accuracy can be solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A microwave sensing device, comprising:
a generation circuit, for generating a generation signal;
a first processing circuit, coupled to the generation circuit, for processing the generation signal, to generate a first processed signal;
a transmitting circuit, coupled to the first processing circuit, for transmitting the first processed signal;
a receiving circuit, for receiving a received signal corresponding to the first processed signal;
a second processing circuit, coupled to the receiving circuit, for processing the received signal, to generate a second processed signal;
a first transferring circuit, coupled to the second processing circuit, for transferring the second processed signal to a first transferred signal;
a removing circuit, coupled to the first transferring circuit, for removing a direct current (DC) component of the first transferred signal, to generate a removed signal;
a third processing circuit, coupled to the removing circuit, for processing the removed signal, to generate a third processed signal; and
a second transferring circuit, coupled to the third processing circuit, for transferring the third processed signal to a second transferred signal.

2. The microwave sensing device of claim 1, wherein the generation signal comprises a single carrier signal, and a center frequency of the generation signal is different from a carrier center frequency.

3. The microwave sensing device of claim 1, wherein the first processing circuit comprises:
a third transferring circuit, coupled to the generation circuit, for transferring the generation signal to a third transferred signal;
a first mixing circuit, coupled to the third transferring circuit, for mixing the third transferred signal according to a periodic signal, to generate a first mixed signal; and
a first amplifying circuit, coupled to the first mixing circuit, for amplifying an amplitude of the first mixed signal, to generate the first processed signal.

4. The microwave sensing device of claim 1, wherein the second processing circuit comprises:
a second amplifying circuit, coupled to the receiving circuit, for amplifying an amplitude of the received signal, to generate a first amplified signal;
a second mixing circuit, coupled to the second amplifying circuit, for mixing the first amplified signal according to a periodic signal, to generate a second mixed signal; and
a first filtering circuit, coupled to the second mixing circuit, for filtering the second mixed signal, to generate the second processed signal.

5. The microwave sensing device of claim 1, wherein the first transferring circuit comprises an analog-to-digital converter (ADC).

6. The microwave sensing device of claim 1, wherein the removing circuit comprises:
a first estimation circuit, coupled to the first transferring circuit, for estimating a first DC bias of the first transferred signal;
a first compensation circuit, coupled to the first transferring circuit and the first estimation circuit, for compensating the first transferred signal according to the first DC bias, to generate a compensated signal;
a third mixing circuit, coupled to the first compensation circuit, for mixing the compensated signal according to a center frequency of the generation signal and a sampling period of the first transferring circuit, to generate a third mixed signal;
a second estimation circuit, coupled to the third mixing circuit, for estimating a second DC bias of the third mixed signal; and
a second compensation circuit, coupled to the third mixing circuit and the second estimation circuit, for compensating the third mixed signal according to the second DC bias, to generate the removed signal.

7. The microwave sensing device of claim 1, wherein the third processing circuit comprises:
a third amplifying circuit, coupled to the removing circuit, for amplifying an amplitude of the removed signal, to generate a second amplified signal;
a second filtering circuit, coupled to the third amplifying circuit, for filtering the second amplified signal, to generate a filtered signal; and
a down sampling circuit, coupled to the second filtering circuit, for sampling the filtered signal, to generate the third processed signal.

8. The microwave sensing device of claim 7, wherein the third processing circuit further comprises:
a determination circuit, coupled to the third amplifying circuit and the second filtering circuit, for determining whether the second amplified signal comprises an interference according to the filtered signal, to generate a determination result.

9. The microwave sensing device of claim 8, wherein the removing circuit removes the DC component of the first transferred signal according to the determination result.

10. The microwave sensing device of claim 1, further comprising:
a detecting circuit, coupled to the second transferring circuit, for detecting a Doppler frequency of a target signal in the second transferred signal.

11. The microwave sensing device of claim 1, further comprising:
an oscillation circuit, coupled to the first processing circuit and the second processing circuit, for generating a periodical signal and providing the periodical signal to the first processing circuit and the second processing circuit.

12. A method for improving a sensing accuracy of a microwave sensing device, comprising:
generating a generation signal;
processing the generation signal, to generate a first processed signal;
transmitting the first processed signal;
receiving a received signal corresponding to the first processed signal;
processing the received signal, to generate a second processed signal;
transferring the second processed signal to a first transferred signal;
removing a direct current (DC) component of the first transferred signal, to generate a removed signal;
processing the removed signal, to generate a third processed signal; and
transferring the third processed signal to a second transferred signal.

13. The method of claim 12, wherein the generation signal comprises a single carrier signal, and a center frequency of the generation signal is different from a carrier center frequency.

14. The method of claim 12, wherein the step of processing the generation signal to generate the first processed signal comprises:
transferring the generation signal to a third transferred signal;
mixing the third transferred signal according to a periodic signal, to generate a first mixed signal; and
amplifying an amplitude of the first mixed signal, to generate the first processed signal.

15. The method of claim 12, wherein the step of processing the received signal to generate the second processed signal comprises:
amplifying an amplitude of the received signal, to generate a first amplified signal;
mixing the first amplified signal according to a periodic signal, to generate a second mixed signal; and
filtering the second mixed signal, to generate the second processed signal.

16. The method of claim 12, wherein the step of removing the DC component of the first transferred signal to generate the removed signal comprises:
estimating a first DC bias of the first transferred signal;
compensating the first transferred signal according to the first DC bias, to generate a compensated signal;
mixing the compensated signal according to a center frequency of the generation signal and a sampling period for the first transferred signal, to generate a third mixed signal;
estimating a second DC bias of the third mixed signal; and
compensating the third mixed signal according to the second DC bias, to generate the removed signal.

17. The method of claim 12, wherein the step of processing the removed signal to generate the third processed signal comprises:
amplifying an amplitude of the removed signal, to generate a second amplified signal;
filtering the second amplified signal, to generate a filtered signal; and
sampling the filtered signal, to generate the third processed signal.

18. The method of claim 17, wherein the step of processing the removed signal to generate the third processed signal further comprises:
determining whether the second amplified signal comprises an interference according to the filtered signal, to generate a determination result.

19. The method of claim 18, wherein the DC component of the first transferred signal is removed according to the determination result.
